(19) United States
(12) Patent Application Publication
(10) Pub. No.: US 2018/0236727 A1
(43) Pub. Date: Aug. 23, 2018

(54) FACILITATION OF PRINTED CONNECTIVITY FOR 3-D PRINTED DEVICES

(71) Applicant: AT&T Mobility II LLC, Atlanta, GA (US)

(72) Inventors: Brian Dominguez, Atlanta, GA (US); Joseph Mosele, Alpharetta, GA (US); Josephine Nord, Atlanta, GA (US)

(21) Appl. No.: 15/438,158

(22) Filed: Feb. 21, 2017

(51) Int. Cl. B29C 67/00; G05B 19/4097; B33Y 50/02

(52) U.S. Cl. CPC B29C 67/0088; H04W 4/008; B33Y 50/02; G05B 19/4097

(57) ABSTRACT

Injecting wireless connectivity components during the manufacturing of 3-dimensional (3-D) printed products can advance 3-D printer technology. A 3-D printing system for injecting wireless connectivity can comprise of a pre-production and a post-production ecosystem. The post-production ecosystem can be responsible for customer care and maintenance and/or updating of any 3-D printed device. Additionally, performance metrics of the 3-D printed device can be used in a feedback loop for subscribing to the printing of additional 3-D printed devices. Furthermore, specifications can be used by the pre-production ecosystem to ensure that the 3-D printed devices are compliant with specific network specifications.

### TECHNICAL FIELD

This disclosure relates generally to facilitating three-dimensional (3-D) printing. More specifically, this disclosure relates to facilitating printed connectivity for 3-D printed devices.

### BACKGROUND

The term 3-D printing originated in reference to a process that deposits a binder material onto powder bed with inkjet printer heads layer by layer. However, more recently, the term is being used in to encompass a wider variety of additive manufacturing techniques. 3-D printing, also known as additive manufacturing (AM), refers to processes used to synthesize a three-dimensional object in which successive layers of material are formed under computer control to create the three-dimensional object. 3-D objects can be of almost any shape or geometry and are produced using digital model data from a 3-D model or another electronic data source such as an additive manufacturing file (AMP).

The above-described background relating to a 3-D printing is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless network comprising a 3-D printer, a 3-D printed device, and a post-production ecosystem according to one or more embodiments.

FIG. 2 illustrates an example 3-D printing store for configuring a 3-D printer according to one or more embodiments.

FIG. 3 illustrates an example customer premises comprising a 3-D printed device according to one or more embodiments.

FIG. 4 illustrates an example post-production ecosystem for a 3-D printed device according to one or more embodiments.

FIG. 5 illustrates example communication between a 3-D printing store, a customer premises, and a post-production ecosystem according to one or more embodiments.

FIG. 6 illustrates example communication between a 3-D printing store, a customer premises, a post-production ecosystem, and 3-D printing specifications according to one or more embodiments.

FIG. 7 illustrates example communication between a 3-D printing store, a customer premises, a post-production ecosystem, 3-D printing specifications, and a pre-production ecosystem according to one or more embodiments.

FIG. 8 illustrates an example schematic system block diagram for 3-D printing connectivity according to one or more embodiments.

FIG. 9 illustrates an example schematic system block diagram for 3-D printing connectivity according to one or more embodiments.

FIG. 10 illustrates an example schematic system block diagram for 3-D printing connectivity according to one or more embodiments.

FIG. 11 illustrates an example block diagram of an example mobile handset operable to engage in a system architecture that facilitates secure wireless communication according to one or more embodiments described herein.

FIG. 12 illustrates an example block diagram of an example computer operable to engage in a system architecture that facilitates secure wireless communication according to one or more embodiments described herein.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various machine-readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As an overview, various embodiments are described herein to facilitate 3-D printing connectivity communication between 3-D printed devices and network devices.

For simplicity of explanation, the methods are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events. Additionally, the methods described hereafter are capable of being stored on an article of manufacture (e.g., a machine-readable storage medium) to facilitate transporting and transferring such methodologies to computers. The term article of manufacture, as used herein, is intended to encompass a computer program accessible from any computer-readable device, carrier, or media, including a non-transitory machine-readable storage medium.

It is noted that although various aspects and embodiments are discussed herein with respect to Universal Mobile Telecommunications System (UMTS) and/or Long Term Evolution (LTE), the disclosed aspects are not limited to a UMTS implementation and/or an LTE implementation or any combination/mesh set of networks. For example, aspects or features of the disclosed embodiments can be exploited in substantially any wireless or satellite communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

Described herein are systems, methods, articles of manufacture, and other embodiments or implementations that can facilitate printed connectivity for 3-D printed devices. Facilitating printed connectivity can be implemented for any type of device with a connection to the communications network such as: a mobile handset, a computer, a handheld device, or the like.

On-demand manufacturing via 3-D printing provides an opportunity to include connectivity in the printing process by injecting connectivity components during the manufacturing process. For instance, common household items can be printed with wireless connectivity already built-in. While there is a large array of applications across industries, this disclosure would enable, for example, toothpaste that meets all regulatory and legal guidelines, to be printed on-demand with microscopic smart-dust type connectivity according to step changes in m-Health applications, monitoring, and preventative care. Another example, connected sheets for a child's bed, can be printed with sensors to detect and securely analyze sleep patterns and/or other designed metrics. Printed connectivity (including, but not limited to Bluetooth, radio frequency identification (RFID), wireless fidelity (Wi-Fi), wireless wide area network (WWAN), low power wide area network (LPWAN), mesh, satellite, etc.) as part of the manufacturing process can reduce supply chain time-to-market. Additionally, it can reduce geographic barriers for delivery, inventory, and production costs by facilitating on-demand, just-in-time inventory. Printable materials can include, but are not limited to: glass with printed connectivity to project images, roads, paint with sensors for next-generation vehicles, smart items (e.g., clothes, sheets, devices), ingestibles (e.g., food, medicine), etc. Consequently, 3-D printing with connectivity can fundamentally change the way that things of the future will connect.

Injecting wireless connectivity components as products are manufactured or printed means that a solution is not designed around connectivity components (well in advance). It further means that a solution is not manufactured or printed first, then connectivity components found, rather, it happens simultaneously. Advances in 3-D printer technology will continue from simple do-it-yourself pens and fashion items (e.g., shoes, and replacement parts) to sophisticated and accessible production/manufacturing in the future. Additionally, 3-D printing can comprise a combination of a) speed, reliability, availability, and accessibility of network connections, and b) miniaturization of wireless connectivity components toward an end-state of micro/dust size that can also be made from durable, tangible, edible, and/or biodegradable materials. Therefore, consumer demand for solutions that are personalized and within arms-reach can compress the supply chain and time-to-market to on-demand solutions literally at their fingertips.

Today there are certified modules that provide connectivity to devices. In some cases the modules can be designed and implemented with the end solution (device/product) in mind, and in other cases an ecosystem partner/entrepreneur can have an idea first, then design around a supported module. Neither case represents on-demand or customized connectivity that is printed during manufacturing.

A series of specifications (guidelines for manufacturing) can be loaded into 3-D printer cartridges that contain the components for connectivity modules and the other required materials for production of the end product. Along with the blueprint for design and licenses (if required), security measures can be drawn from an ecosystem warehouse and loaded into the printer for production. The printer can then manufacture the product and directly inject connectivity, based on the end customer requests. During the injection/printing process, other components that facilitate next-generation connected devices can also be included, such as sensors to capture and analyze user behavior and provide a feedback loop to the ecosystem that developed it. Additionally, over-the-air updates can be received by the ecosystem to support continued innovation. An extended ecosystem can comprise several components. Specifications for connectivity components can cover a wide-array of guidelines and relevant certifications including, but not limited to, legal, regulatory, and policy. The ecosystem can comprise partners responsible for innovation and planning by developers, manufacturers, and/or consumers. Stores, which include both physical and virtual components, can bring together specification inputs, requirements, blueprints, content, licenses, test-plans, security components from a warehouse (by way of the broader ecosystem), cartridges of printed material, and/or the printer mechanism itself. Customers can interact with the ecosystem, via several different means, as an end-user, a manufacturer, or at another portion of the value chain altogether. A portal can enable the interaction between the customer, the store, and the ecosystem and can comprise the interface to initiate and monetize orders. Metrics and analytics can capture usage, behavior, indicators, and feedback from the product. A post-production ecosystem can facilitate subscription opportunities, customer care, maintenance, interact with the product, and interact with the customer in real-time and/or dynamically.

Specifications can be shared in a streamlined manner, updated, and/or certified in real time. Ecosystem partners can access real-time usage information from customers (where policy allows) and can spark further innovation. Virtual stores can comprise items that can be printed on-demand and allow customers more participation in the production process. While the relationship between end-user and manufacturer can be more direct, there can also be additional participation opportunities for component providers within the supply chain. Therefore customer feedback data can be looped more directly into the ecosystem for innovation by the post-production ecosystem.

A secure database can house product/solution guidelines for manufacturing. These guidelines can include, but are not limited to, updateable and certified terms of use, global nuances, connectivity protocols such as Bluetooth, RFID, Wi-Fi, WWAN, LPWA, mesh, satellite (which may vary by provider), a host of governmental regulations on use and/or consumption, etc. Specifications can also be made available for on-demand use via secure communication protocols and loaded onto the cartridge.

An ecosystem of thought-leaders can comprise: developers, traditional original equipment manufacturers (OEM), crowd-sourced concepts, and consumers themselves. This is where the products/solutions are imagined, regardless of the technical, legal/regulatory guidelines required from the specifications process. Specific product/solution concepts can be securely transmitted to a warehouse and/or database for housing and validation against established policies.

The store can have both virtual and physical components. It can be a physical location where cartridges are loaded into printers, adjusted, and/or refilled. Virtually, the store can represent two key components with multiple touch-points: 1) printers can have several connected inputs; and 2) cartridges can provide the inputs as well as related materials for production. Additionally, the touch-points can comprise: 1) a customer-facing portal for transactions; 2) specifications ensuring production meets established guidelines, policies, and/or laws; and 3) a warehouse interface for the product/solution-specific manufacturing inputs.

A virtual warehouse can serve as a repository/security vault for inputs that can be drawn into a print/production request upon demand. Ancillary inputs can be included as needed (e.g., required test plans, licensing, security/privacy/biometric protocols). Furthermore, over-the-air updates (OTA) can be housed for post-production (e.g., upgrades, fixes, etc.) in the event that updates are needed or required to go direct-to-product after initial manufacturing. Inputs from the warehouse can be securely transmitted to the printer for manufacturing.

The cartridges can contain the required material for manufacturing and packaging according to related specifications. These can be refilled and used in conjunction with other cartridges as appropriate and/or needed. The transmission of cartridges to printer can include physical loading as well as connected transmission of required specifications.

The printer can take many forms, shapes, sizes and use many different types of power for production. The printer can print items including, but not limited to: a pen, edible material, medicine/hygiene products, and/or large-scale manufacturing (housing, vehicles, technology/electronics). The finished product can be assembled by the printer using specifications loaded into a cartridge and inputs from the warehouse by way of the broader ecosystem. Quality assurance and testing can also be performed by the printer.

A consumer-facing portal can manage multiple interactions. The consumer-facing portal can enable customers to place orders, which can trigger the appropriate product-specific inputs for use in cartridges. This represents the monetization/billing method for the manufacturing process and additionally allows customers to request related services (e.g., connectivity plans, ancillary plans, products, and/or subscriptions). While the portal can initiate a print job, it can also send use cases and requests to the ecosystem at large, for those partners who have elected to participate. While the primary function of the warehouse is to deliver inputs to the printer for manufacturing, post-manufacturing updates can be delivered over-the-air to the product directly.

The customer represents the initial transaction/order and can be a consumer, a manufacturer, and/or value-chain suppliers. The products comprising embedded sensors can securely transmit available data for ingestion, analysis, and other downstream uses. Actual usage metrics vs. expected benchmarks can be captured and stored along with customer feedback. Relevant and available metrics from actual usage and customer feedback can be securely transmitted to a warehouse/database for the participating ecosystem to react to, wherein the reaction can include but is not limited to, a product or solution enhancement, a fix, a new product/solution, a new go-to-market offer, etc.

Depending on the product/solution manufactured, there can be a series of subscriptions for the customer including, but not limited to: data (connectivity) to enable connected devices, feature use or upgrades, and professional services (e.g., use instruction, consulting, etc.). The interaction between customer and associated care groups can occur via established relationships. Customer care can comprise: help desks, online forums, expectation-setting, and where appropriate, solution-selling.

In the event that maintenance is required, customers can engage repair facilities. While this can occur directly between the customer and maintenance, it can also occur via customer care. In the event that OTA updates are insufficient for upgrades or maintenance, high-touch repair partners can address the customer-related issues. Relevant and available metrics from maintenance processes can be securely transmitted and fed back to the warehouse for the participating ecosystem to react in a variety of manners, including, but not limited to: product or solution enhancements, fixes, upgrades related to a network evolution, new products/solutions, new go-to-market offers, etc.

It should also be noted that an artificial intelligence (AI) component can facilitate automating one or more features in accordance with the disclosed aspects. A memory and a processor as well as other components can include functionality with regard to the figures. The disclosed aspects in connection with injecting 3-D printed devices with wireless connectivity components can employ various AI-based schemes for carrying out various aspects thereof. For example, a process for detecting one or more trigger events, reducing a number of connectivity components as a result of the one or more trigger events, and modifying one or more reported measurements, and so forth, can be facilitated with an example automatic classifier system and process.

An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed. In the case of wireless connectivity injection, for example, attributes can be a specification, an input value, etc. In another example, the attributes can be a frequency band, a technology, and the presence of an object and the classes can be an output power reduction value.

A support vector machine (SVM) is an example of a classifier that can be employed. The SVM can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also may be inclusive of statistical regression that is utilized to develop models of priority.

The disclosed aspects can employ classifiers that are explicitly trained (e.g., via a generic training data) as well as implicitly trained (e.g., via observing mobile device usage as it relates to triggering events, observing network frequency/technology, receiving extrinsic information, and so on). For example, SVMs can be configured via a learning or training phase within a classifier constructor and feature selection module. Thus, the classifier(s) can be used to automatically learn and perform a number of functions, including but not limited to modifying a transmit power of the connectivity components, modifying one or more reported measurements, and so forth. The criteria can include, but is not limited to, predefined values, frequency attenuation tables or other parameters, service provider preferences and/or policies, and so on.

In one embodiment, described herein is a method comprising receiving manufacturing input data representative of a manufacturing specification that defines product characteristics. The method can also comprise receiving assembly-line input data representative of an assembly-line input. Additionally, based on the manufacturing input data and the assembly-line input data, the method can comprise assembling a product that satisfies the product characteristics of the manufacturing specification, wherein the assembling comprises introducing a wireless connectivity interface device into the product during the assembling.

According to another embodiment, a system can facilitate, the receiving manufacturing input data representative of a manufacturing specification for a device. Furthermore, the system can facilitate receiving end-user specification data, representative of a requested specification related to the device, from a user device associated with a user identity. Consequently, in response to the receiving the manufacturing input data and the receiving the end-user specification data, the system can facilitate assembling the device according to the manufacturing input data and the end-user specification data, wherein the assembling comprises injecting a wireless connectivity device into the device during the assembling.

According to yet another embodiment, described herein is a machine-readable storage medium that can perform the operations comprising receiving device performance data representative of a performance of a first device; and based on the device performance data, generating manufacturing input data representative of a manufacturing specification for a second device. Additionally, in response to the generating the manufacturing input data, and during an assembly of the second device in accordance with the manufacturing input data, the machine-readable storage medium can also perform operations comprising introducing a wireless network interface into the second device.

These and other embodiments or implementations are described in more detail below with reference to the drawings.

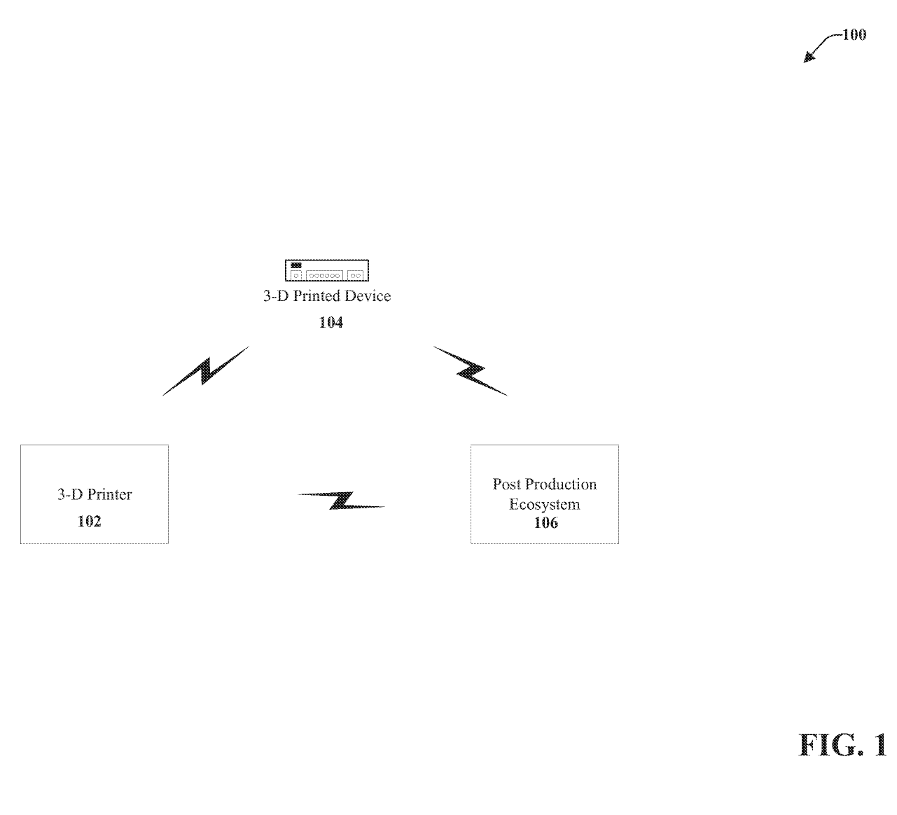

Referring now to FIG. 1, illustrated is an example wireless network comprising a 3-D printer, a 3-D printed device, and a post-production ecosystem according to one or more embodiments. 3-D printing system 100 can comprise a 3-D printer 102, a 3-D printed device 104, and a post-production ecosystem 106. The 3-D printer 102 can be configured to print the 3-D printed device 104 (e.g., a pen, edible material, medicine/hygiene products, large-scale manufacturing items, etc.). The 3-D printed device 104 can be assembled by the printer using specifications loaded into a cartridge and inputs from a warehouse. The 3-D printer 102 can also incorporate wireless connectivity components (e.g., Bluetooth, RFID, Wi-Fi, WWAN, LPWA, mesh, satellite, etc.) into the 3-D printed device 104. In one embodiment, after production, the 3-D printed device 104 can communicate with the 3-D printer 102 and with a post-production ecosystem 106.

The post-production ecosystem 106 can comprise various functionality including, but not limited to: subscriptions to the 3-D printed device 104 and/or services therewith, customer care for the 3-D printed device 104, and/or maintenance for the 3-D printed device 104. The post-production ecosystem 106 can allow analytics and metrics received from the 3-D printed device 104 to be shared with the 3-D printer 102 to mitigate potentially foreseeable service issues during a future pre-production phase.

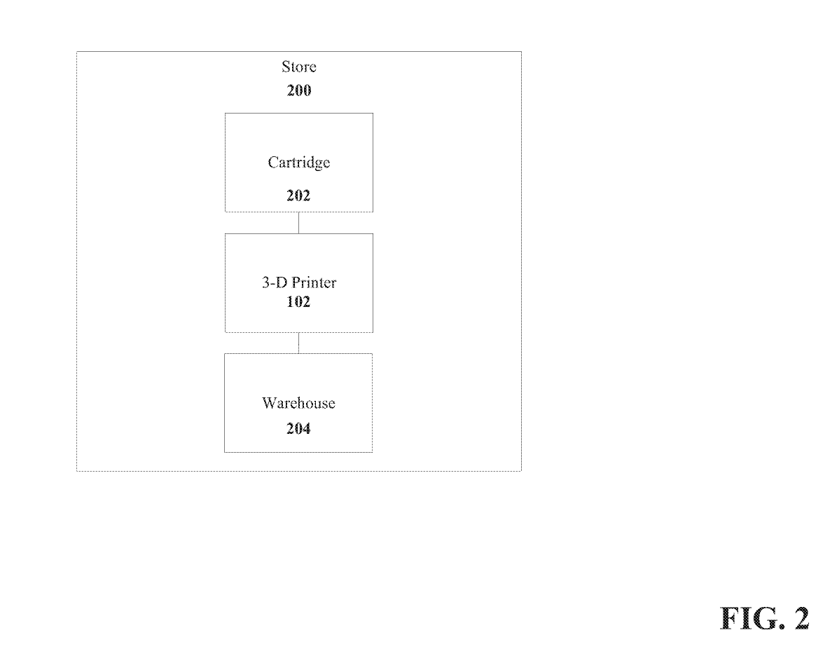

Referring now to FIG. 2, illustrated is an example 3-D printing store for configuring a 3-D printer according to one or more embodiments. A 3-D printing store 200 can comprise the 3-D printer 102, a cartridge 202, and a warehouse 204. The 3-D printing store 200 can have both virtual and physical components where cartridges are loaded into the 3-D printer 102, adjusted, and/or refilled. The 3-D printer 102 has several connected inputs coming from the 3-D printing store 200. The cartridge 202 can provide additional inputs and materials for production of the 3-D printed device 104. The cartridge 202 can contain the required material for manufacturing, and packaging, including related specifications. The cartridge 202 can be refilled and used in conjunction with other cartridges as appropriate and/or needed. The transmission of cartridge 202 to the 3-D printer 102 can include physical loading as well as wirelessly connected transmission of required specifications. For example, manufacturing specifications (e.g., guidelines for manufacturing) can be loaded onto the cartridge 202 that contain the components for connectivity modules and the other required materials for production of the 3-D printed device 104. The 3-D printer 102 can then manufacture the 3-D printed device 104 and directly inject wireless connectivity components, based on an end customer request.

The warehouse 204 can serve as a repository for inputs that can be drawn into a print/production requests upon demand. For instance, the warehouse 204 inputs can comprise required test plans, licensing, security/privacy/biometric protocols, etc. Furthermore, OTA updates can be housed in the warehouse 204 for post-production upgrades/fixes/etc. Therefore, inputs from the warehouse can be transmitted to the 3-D printer 102 for manufacturing.

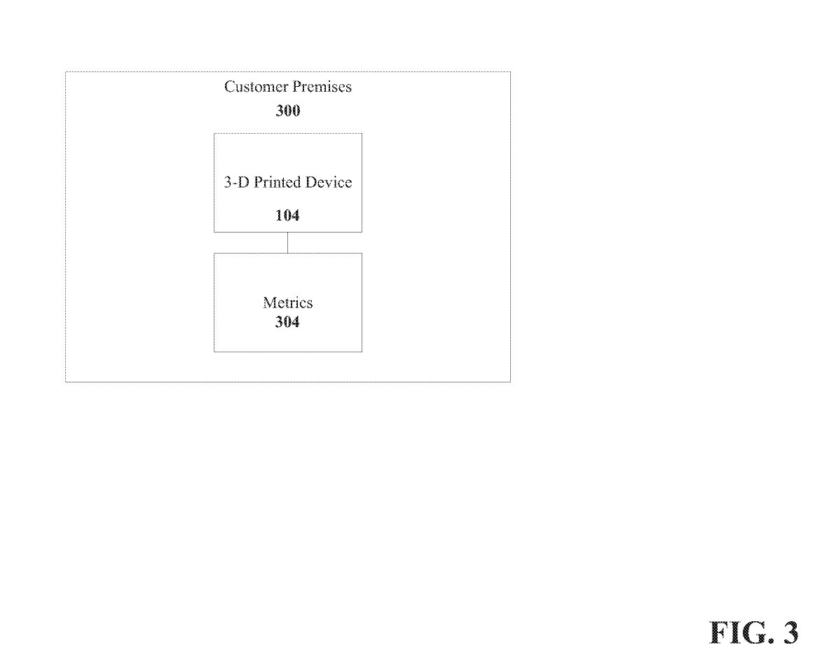

Referring now to FIG. 3, illustrated is an example customer premises comprising a 3-D printed device according to one or more embodiments. A customer premises 300, which can be virtual, can comprise the 3-D printed device 104 and metrics 304 associated with the 3-D printed device 104. For example, if the 3-D printed device 104 is a wireless router that is being operated at the customer premises 300, metrics 304 (e.g., bandwidth, speed, reliability, throughput, etc.) can be obtained regarding the wireless router. The metrics 304 can be stored at the customer premises 300. However, the metrics 304 can also be sent to a pre-production ecosystem and/or a post-production ecosystem 106. It should also be noted that in an alternative embodiment the 3-D printer 102 can be located at the customer premises 300.

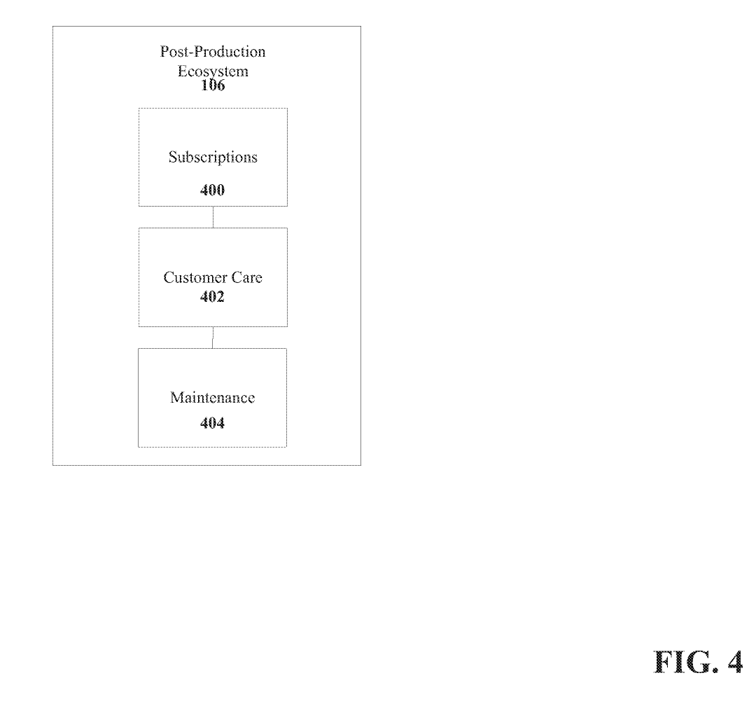

Referring now to FIG. 4, illustrated is an example post-production ecosystem for a 3-D printed device according to one or more embodiments. The post-production ecosystem 106 can facilitate subscriptions 400, customer care 402, and/or maintenance at maintenance block 404. Customers can subscribe to subscription-based services via an interactive service platform. It should be noted that some subscription-based services can comprise data to enable connected devices, feature use or upgrades, and professional services. For example, if the 3-D printed device 104 is a laptop, the customer could subscribe to malware maintenance services via the subscriptions 400 service.

Customer care 402 can comprise: help desks, online forums, expectation-setting, and where appropriate, solution-selling with regards to the 3-D printed device 104. The interaction between customer and associated care groups can occur via established relationships between the subscriptions 400 and maintenance block 404.

At the maintenance block 404, customers can engage repair facilities. It should be noted that customers can also engage repair facilities via customer care 402. In the event that maintenance is required, customer can engage high-touch repair facilities. While this can occur directly between the customer premises 300 and maintenance block 404, it can also occur via the customer care block 402. In some scenarios OTA updates and/or upgrades can mitigate any maintenance issues. Additionally metrics 304 from maintenance processes can be securely transmitted and fed back to the warehouse 204 for the participating ecosystem (e.g., pre-production, post-production) to respond accordingly, including, but not limited to: product or solution enhancements, fixes, new products/solutions, new go-to-market offers, etc.

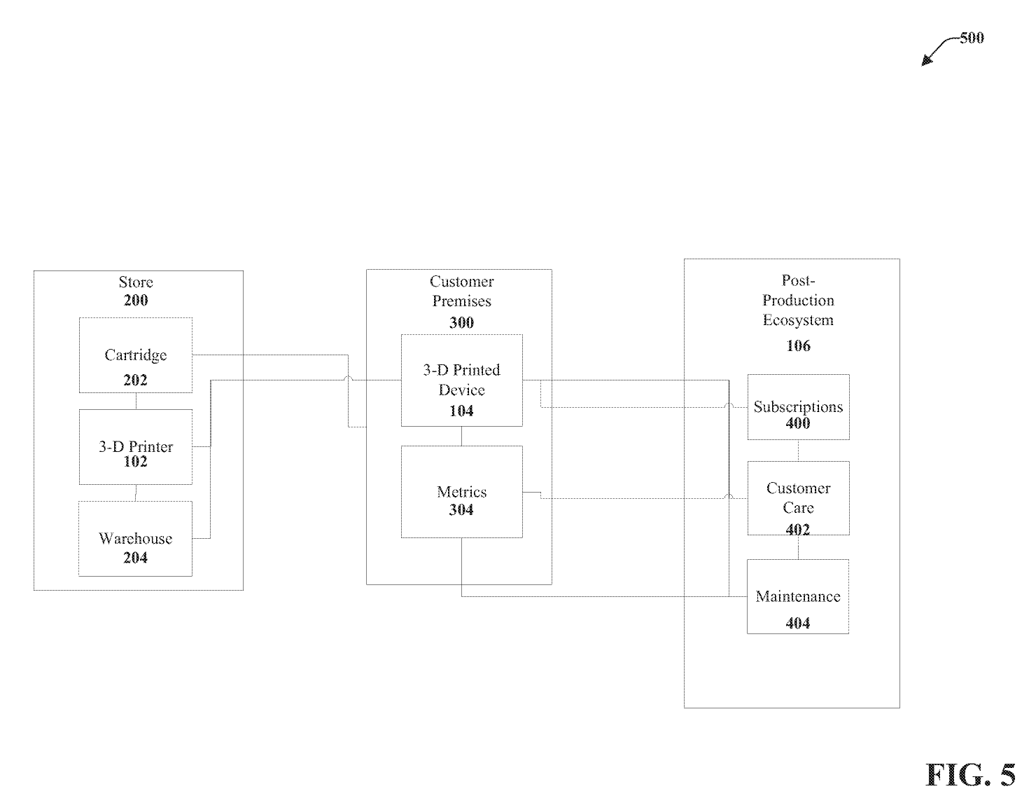

Referring now to FIG. 5, illustrated is an example communication between a 3-D printing store, a customer premises, and a post-production ecosystem according to one or more embodiments. A printed wireless connectivity system 500 can comprise the 3-D printing store 200, the customer premises 300, and the post-production ecosystem 106. The cartridge 202 can transmit and receive information to and from the customer premises 300. For example, during an initial order request, the cartridge can receive information from the customer premises 300 comprising what type of materials a 3-D printed device should be made of. The 3-D printer 102 can use the data from the customer premises 300 and data from the warehouse 204 (e.g., a security policy) to then create the 3-D printed device 104. During use, the 3-D printed device 104 can generate performance metrics 304 associated with a performance of the 3-D printed device 104. The 3-D printed device 104 can then be subject to maintenance 404 or maintenance requests, via customer care 402, based on the metrics 304. Additionally, the post-productions ecosystem 106 can facilitate subscription-based service offerings for the 3-D printed device 104 via the subscriptions 400.

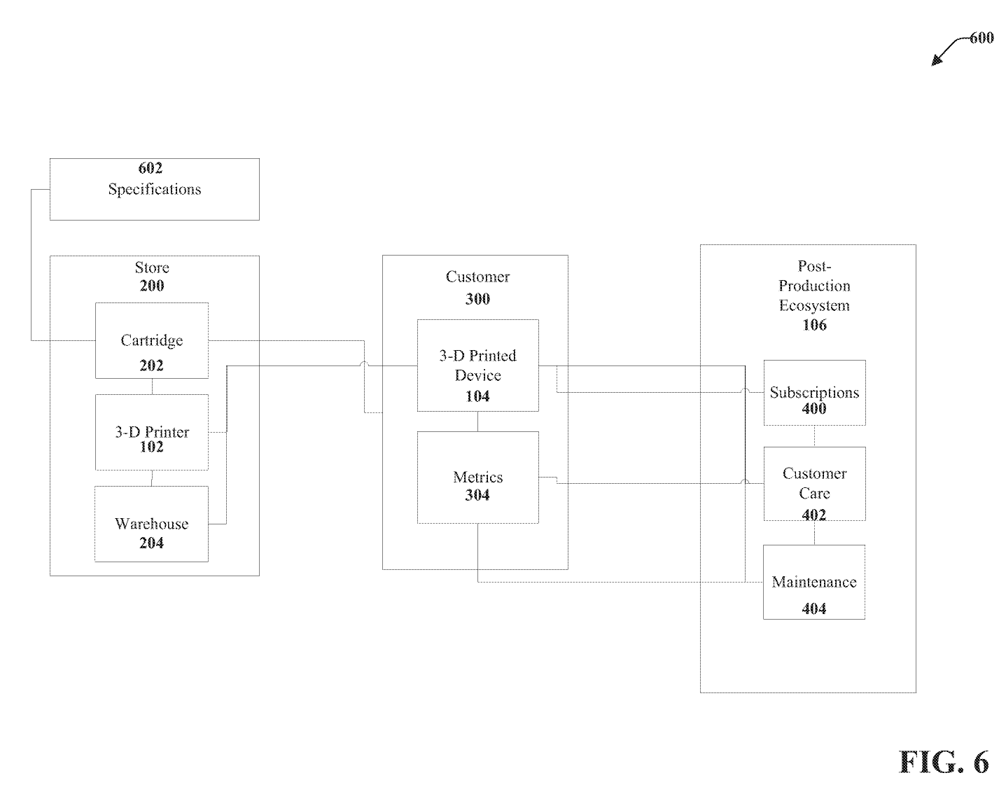

Referring now to FIG. 6, illustrated is an example communication between a 3-D printing store, a customer premises, a post-production ecosystem, and 3-D printing specifications according to one or more embodiments. Another printed wireless connectivity system 600 can comprise the 3-D printing store 200, the customer premises 300, the post-production ecosystem 106, and specifications 602. Repetitive description of like elements employed in respective embodiments is omitted for sake of brevity. The specifications 602 can comprise a secure database for housing product/solution guidelines for manufacturing. These guidelines can include, but are not limited to: updateable and certified terms of use, global nuances, connectivity protocols such as Bluetooth, RFID, Wi-Fi, WWAN, LPWA, mesh, satellite, legal specifications, regulatory specifications, and/or a host of governmental regulations on use/consumption. The specifications 602 can be transmitted to the cartridge 202 to determine how the 3-D printed device 104 should be created.

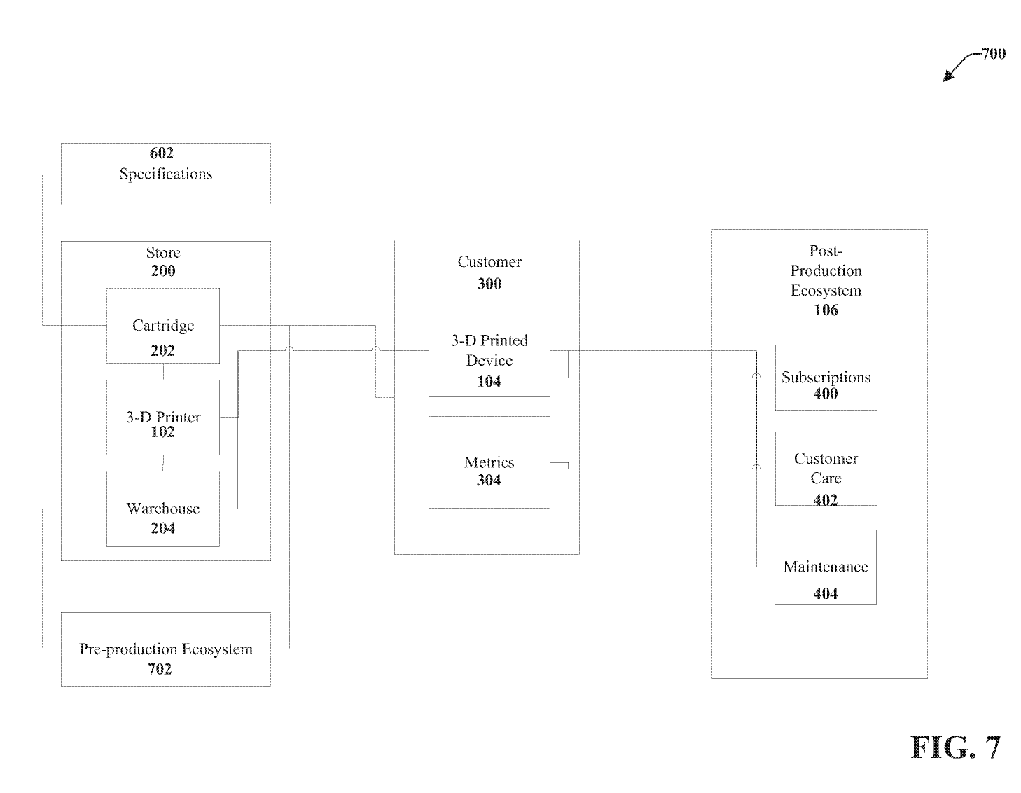

Referring now to FIG. 7, illustrated is an example communication between a 3-D printing store, a customer premises, a post-production ecosystem, 3-D printing specifications, and a pre-production ecosystem according to one or more embodiments. In yet another embodiment, a printed wireless connectivity system 700 can comprise the 3-D printing store 200, the customer premises 300, the post-production ecosystem 106, specifications 602, and a pre-production ecosystem 702. Repetitive description of like elements employed in respective embodiments is omitted for sake of brevity.

The pre-production ecosystem 702 can comprise inputs from partners including developers, manufacturers, consumer use cases, crowd-sourced concepts, and from the customer premises 300. Concepts can be securely transmitted to a database of the warehouse 204 for storing and validation against established policies. Metrics 304 from a first 3-D printed device 104 can be fed back to the pre-production ecosystem 702 to develop a second 3-D printed device.

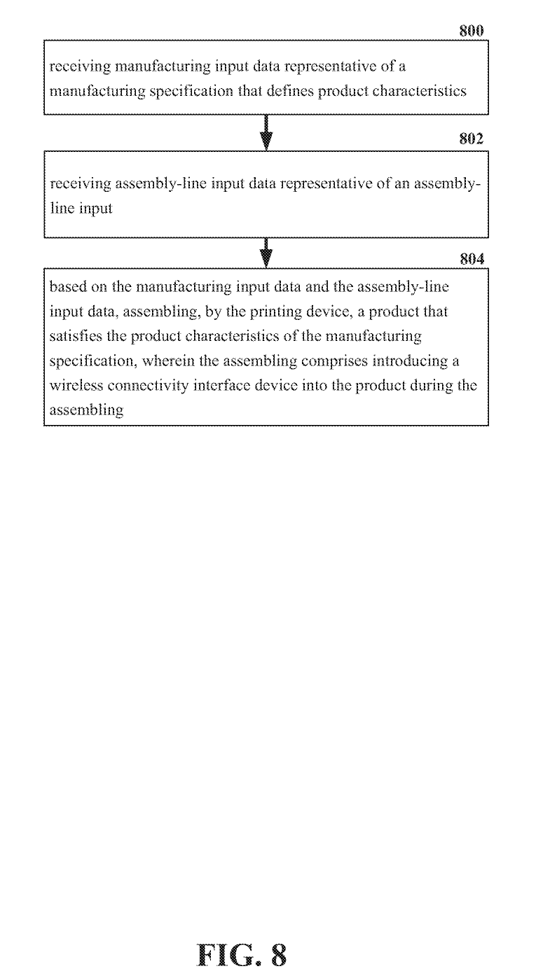

Referring now to FIG. 8, illustrated is an example schematic system block diagram for 3-D printing connectivity according to one or more embodiments. At element 800, a method can comprise receiving (e.g., via the specification block 602) manufacturing input data representative of a manufacturing specification that defines product characteristics. Additionally, at element 802, the method can comprise receiving (e.g., via the warehouse 204) assembly-line input data representative of an assembly-line input. Based on the manufacturing input data and the assembly-line input data, at element 804 the method can comprise assembling (e.g., via the 3-D printer 102) a product (e.g., the 3-D printed device 104) that satisfies the product characteristics of the manufacturing specification, wherein the assembling comprises introducing a wireless connectivity interface device into the product during the assembling.

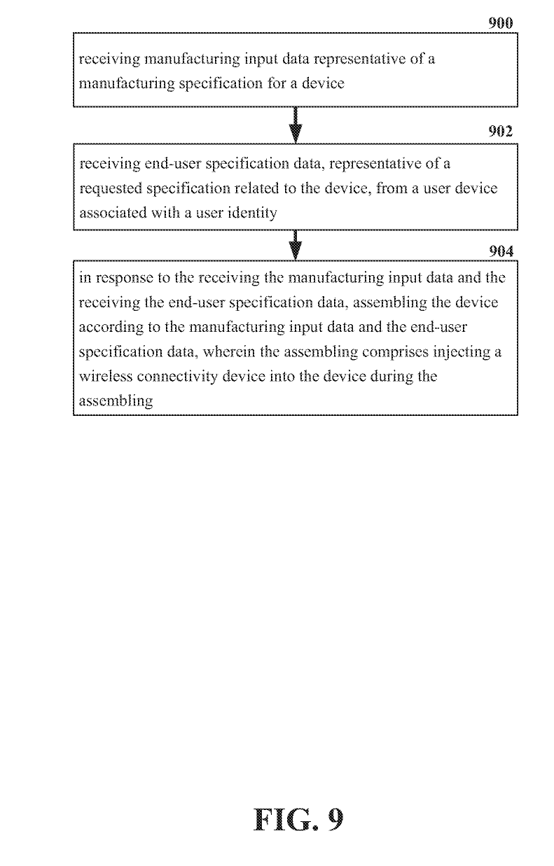

Referring now to FIG. 9, illustrated is an example schematic system block diagram for 3-D printing connectivity according to one or more embodiments. At element 900, a system can comprise receiving manufacturing input data (e.g., via the specification block 702) representative of a manufacturing specification for a device. Thus, at element 902, the system can comprise receiving end-user specification data (e.g., via the customer premises 300), representative of a requested specification related to the device, from a user device associated with a user identity. Furthermore, at element 904, in response to the receiving the manufacturing input data and the receiving the end-user specification data, the system can comprise assembling (e.g., via the 3-D printer 102) the device (e.g., the 3-D printed device 104) according to the manufacturing input data and the end-user specification data, wherein the assembling comprises injecting a wireless connectivity device into the device during the assembling.

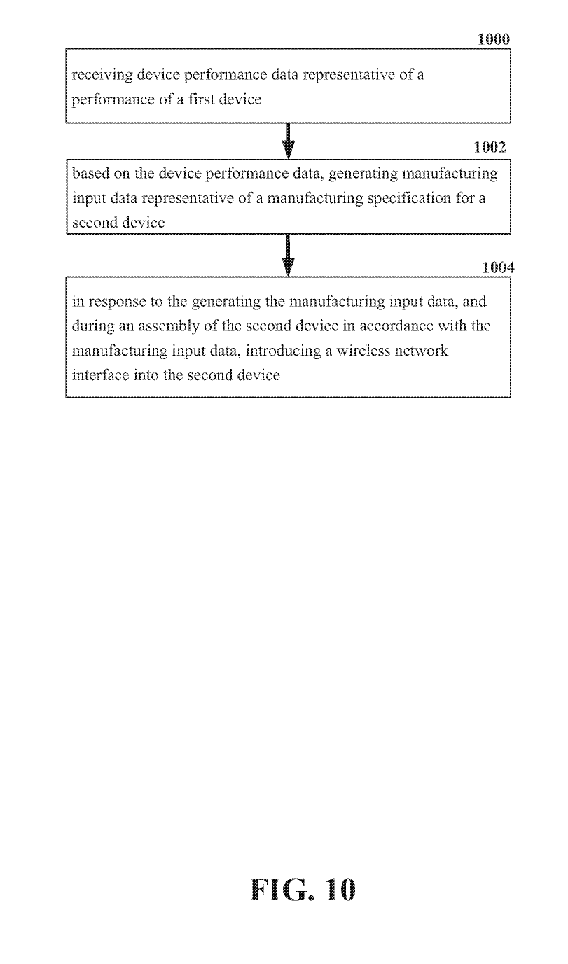

Referring now to FIG. 10, illustrated is an example schematic system block diagram for 3-D printing connectivity according to one or more embodiments. At element 1000, a machine-readable storage medium can facilitate operations comprising receiving device (e.g., the 3-D printed device 104) performance data representative of a performance of a first device. Based on the device (e.g., the 3-D printed device 104) performance data, generating manufacturing input data (e.g., via the specification block 702) representative of a manufacturing specification for a second device. Consequently, in response to the generating the manufacturing input data, and during an assembly of the second device in accordance with the manufacturing input data, introducing (e.g., via the 3-D printer 102) a wireless network interface into the second device.

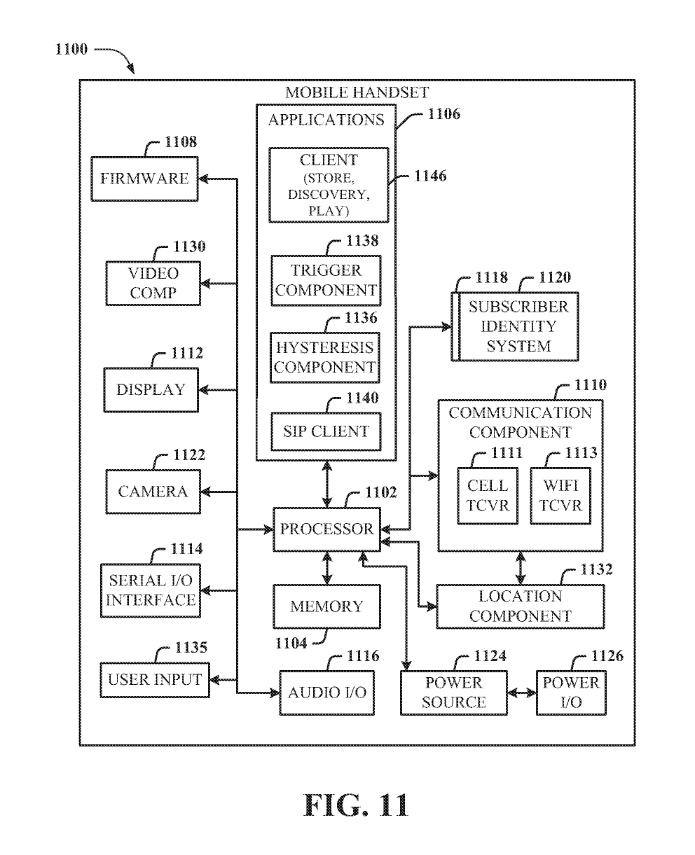

Referring now to FIG. 11, illustrated is a schematic block diagram of an exemplary end-user device such as a mobile device 1100 capable of connecting to a network in accordance with some embodiments described herein. Although a mobile handset 1100 is illustrated herein, it will be understood that other devices can be a mobile device, and that the mobile handset 1100 is merely illustrated to provide context for the embodiments of the various embodiments described herein. The following discussion is intended to provide a brief, general description of an example of a suitable environment 1100 in which the various embodiments can be implemented. While the description includes a general context of computer-executable instructions embodied on a machine-readable storage medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1100 includes a processor 1102 for controlling and processing all onboard operations and functions. A memory 1104 interfaces to the processor 1102 for storage of data and one or more applications 1106 (e.g., a video player software, user feedback component software, etc.). Other applications can include voice recognition of predetermined voice commands that facilitate initiation of the user feedback signals. The applications 1106 can be stored in the memory 1104 and/or in a firmware 1108, and executed by the processor 1102 from either or both the memory 1104 or/and the firmware 1108. The firmware 1108 can also store startup code for execution in initializing the handset 1100. A communications component 1110 interfaces to the processor 1102 to facilitate wired/wireless communication with external systems, e.g., cellular networks, VoIP networks, and so on. Here, the communications component 1110 can also include a suitable cellular transceiver 1111 (e.g., a GSM transceiver) and/or an unlicensed transceiver 1113 (e.g., Wi-Fi, WiMax) for corresponding signal communications. The handset 1100 can be a device such as a cellular telephone, a PDA with mobile communications capabilities, and messaging-centric devices. The communications component 1110 also facilitates communications reception from terrestrial radio networks (e.g., broadcast), digital satellite radio networks, and Internet-based radio services networks.

The handset 1100 includes a display 1112 for displaying text, images, video, telephony functions (e.g., a Caller ID function), setup functions, and for user input. For example, the display 1112 can also be referred to as a “screen” that can accommodate the presentation of multimedia content (e.g., music metadata, messages, wallpaper, graphics, etc.). The display 1112 can also display videos and can facilitate the generation, editing and sharing of video quotes. A serial I/O interface 1114 is provided in communication with the processor 1102 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

The handset 1100 can include a slot interface 1118 for accommodating a SIC (Subscriber Identity Component) in the form factor of a card Subscriber Identity Module (SIM) or universal SIM 1120, and interfacing the SIM card 1120 with the processor 1102. However, it is to be appreciated that the SIM card 1120 can be manufactured into the handset 1100, and updated by downloading data and software.

The handset 1100 can process IP data traffic through the communication component 1110 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1122 (e.g., a camera) can be provided for decoding encoded multimedia content. The video processing component 1122 can aid in facilitating the generation, editing and sharing of video quotes. The handset 1100 also includes a power source 1124 in the form of batteries and/or an AC power subsystem, which power source 1124 can interface to an external power system or charging equipment (not shown) by a power I/O component 1126.

The handset 1100 can also include a video component 1130 for processing video content received and, for recording and transmitting video content. For example, the video component 1130 can facilitate the generation, editing and sharing of video quotes. A location tracking component 1132 facilitates geographically locating the handset 1100. As described hereinabove, this can occur when the user initiates the feedback signal automatically or manually. A user input component 1134 facilitates the user initiating the quality feedback signal. The user input component 1134 can also facilitate the generation, editing and sharing of video quotes. The user input component 1134 can include such conventional input device technologies such as a keypad, keyboard, mouse, stylus pen, and/or touch screen, for example.

Referring again to the applications 1106, a hysteresis component 1136 facilitates the analysis and processing of hysteresis data, which is utilized to determine when to associate with the access point. A software trigger component 1138 can be provided that facilitates triggering of the hysteresis component 1138 when the Wi-Fi transceiver 1113 detects the beacon of the access point. A SIP client 1140 enables the handset 1100 to support SIP protocols and register the subscriber with the SIP registrar server. The applications 1106 can also include a client 1142 that provides at least the capability of discovery, play and store of multimedia content, for example, music.

The handset 1100, as indicated above related to the communications component 810, includes an indoor network radio transceiver 1113 (e.g., Wi-Fi transceiver). This function supports the indoor radio link, such as IEEE 802.11, for the dual-mode GSM handset 1100. The handset 1100 can accommodate at least satellite radio services through a handset that can combine wireless voice and digital radio chipsets into a single handheld device.

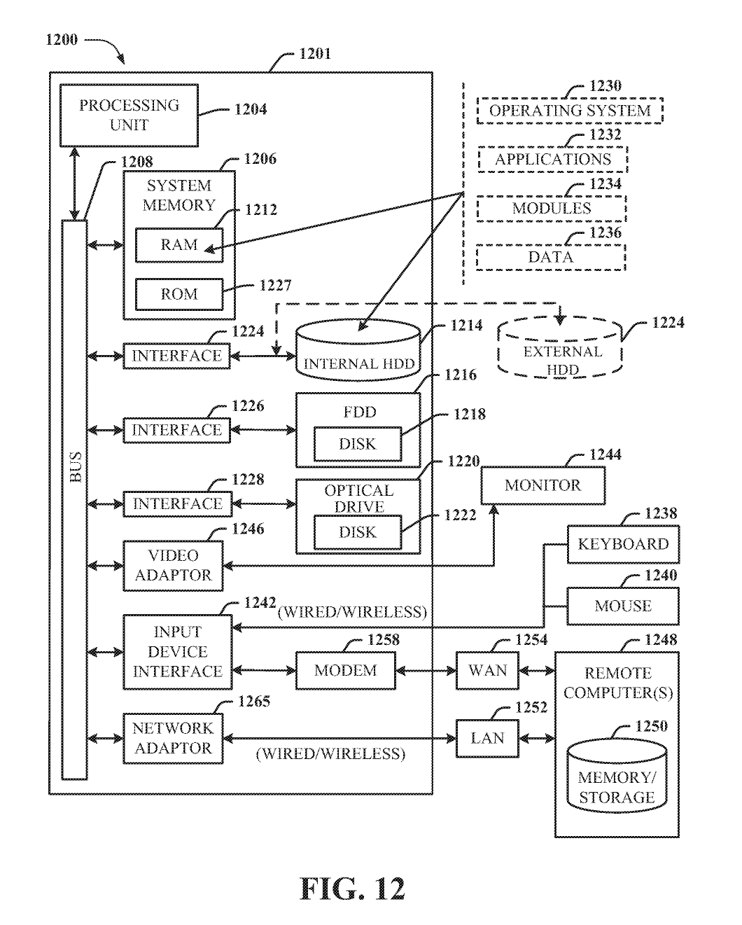

Referring now to FIG. 12, there is illustrated a block diagram of a computer 1200 operable to execute a system architecture that facilitates establishing a transaction between an entity and a third party. The computer 1200 can provide networking and communication capabilities between a wired or wireless communication network and a server and/or communication device. In order to provide additional context for various aspects thereof, FIG. 12 and the following discussion are intended to provide a brief, general description of a suitable computing environment in which the various aspects of the innovation can be implemented to facilitate the establishment of a transaction between an entity and a third party. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 12, implementing various aspects described herein with regards to the end-user device can include a computer 1200, the computer 1200 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1227 and random access memory (RAM) 1212. A basic input/output system (BIOS) is stored in a non-volatile memory 1227 such as ROM, EPROM, EEPROM, which BIOS contains the basic routines that help to transfer information between elements within the computer 1200, such as during start-up. The RAM 1212 can also include a high-speed RAM such as static RAM for caching data.

The computer 1200 further includes an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1294 interface technologies. Other external drive connection technologies are within contemplation of the subject innovation.

The drives and their associated computer-readable media provide nonvolatile storage of data, data structures, computer-executable instructions, and so forth. For the computer 1200 the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer 1200, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1200 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 2394 serial port, a game port, a USB port, an IR interface, etc.

A monitor 1244 or other type of display device is also connected to the system bus 1208 through an interface, such as a video adapter 1246. In addition to the monitor 1244, a computer 1200 typically includes other peripheral output devices (not shown), such as speakers, printers, etc.

The computer 1200 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment device, a peer device or other common network node, and typically includes many or all of the elements described relative to the computer, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1200 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1200 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 through the input device interface 1242. In a networked environment, program modules depicted relative to the computer, or portions thereof, can be stored in the remote memory/storage device 1250. It will be appreciated that the network connections shown are exemplary and other means of establishing a communications link between the computers can be used.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a printing device comprising a processor, manufacturing input data representative of a manufacturing specification that defines product characteristics;
receiving, by the printing device, assembly-line input data representative of an assembly-line input; and
based on the manufacturing input data and the assembly-line input data, assembling, by the printing device, a product that satisfies the product characteristics of the manufacturing specification, wherein the assembling comprises introducing a wireless connectivity interface device into the product during the assembling.

2. The method of claim 1, further comprising:
receiving, by the printing device, policy specification data representing a policy associated with the manufacturing specification.

3. The method of claim 2, wherein the policy specification data comprises connectivity data representative of a wireless connectivity policy to be applied to the wireless connectivity interface device.

4. The method of claim 2, further comprising:
receiving, by the printing device, customization data related to a customization of the product.

5. The method of claim 4, wherein the customization data is received from a device associated with a user identity determined to be authorized to customize the product.

6. The method of claim 5, wherein the customization data is received from a developer identity determined to have participated in development of the product.

7. The method of claim 1, wherein the assembly-line input data comprises license data representative of a license to perform the assembling of the product.

8. A system, comprising:
a processor; and
a memory that stores executable instructions that, when executed by the processor, facilitate performance of operations, comprising:
receiving manufacturing input data representative of a manufacturing specification for a device;
receiving end-user specification data, representative of a requested specification related to the device, from a user device associated with a user identity; and
in response to the receiving the manufacturing input data and the receiving the end-user specification data, assembling the device according to the manufacturing input data and the end-user specification data, wherein the assembling comprises injecting a wireless connectivity device into the device during the assembling.

9. The system of claim 8, wherein the device is a first device, and wherein the manufacturing input data comprises usage data associated with a second device.

10. The system of claim 8, wherein the end-user specification data is received in accordance with a subscription authorized for the user identity.

11. The system of claim 8, wherein the wireless connectivity device comprises a radio frequency identification device.

12. The system of claim 8, wherein the wireless connectivity device comprises a wireless fidelity device.

13. The system of claim 8, wherein the manufacturing input data comprises regulatory data representative of a regulatory policy applicable to the assembling the device.

14. The system of claim 8, wherein the operations further comprise:
receiving device-specific data representative of a device specification associated with a functional operation of the device.

15. A machine-readable storage medium, comprising executable instructions that, when executed by a processor, facilitate performance of operations, comprising:
receiving device performance data representative of a performance of a first device;
based on the device performance data, generating manufacturing input data representative of a manufacturing specification for a second device;
in response to the generating the manufacturing input data, and during an assembly of the second device in accordance with the manufacturing input data, introducing a wireless network interface into the second device.

16. The machine-readable storage medium of claim 15, wherein the wireless network interface comprises an interface adhering to a Bluetooth protocol.

17. The machine-readable storage medium of claim 15, wherein the device performance data comprises maintenance data representative of a maintenance action to be performed on the first device.

18. The machine-readable storage medium of claim 15, wherein the device performance data comprises feedback data representative of feedback received based on an observation of the performance of the first device and received from a third device associated with a user identity authorized to provide the feedback regarding the first device.

19. The machine-readable storage medium of claim 15, wherein the operations further comprise:
receiving manufacturing material from a cartridge determined to be part of the assembly of the second device.

20. The machine-readable storage medium of claim 15, wherein the manufacturing input data comprises specification data associated with a production regulation applicable to the assembly of the second device.
